(19) United States
(12) Patent Application Publication
(10) Pub. No.: US 2010/0255697 A1
(43) Pub. Date: Oct. 7, 2010

(54) USB STICK

(75) Inventor: Xavier Cabes, Antwerpen (BE)

Correspondence Address: DOWELL & DOWELL P.C., 103 Oronoco St., Suite 220, Alexandria, VA, 22314, US

(73) Assignee: PROVISTA BESLOTEN VENNOOTSCHAP MET BEPERKTE AANSPRAKE LIJKHEID, Zeebrugge (BE)

(21) Appl. No.: 12/746,799

(22) PCT Filed: Dec. 8, 2008
(86) PCT No.: PCT/BE08/00100

§ 371 Date: Jun. 8, 2010

(30) Foreign Application Priority Data
Dec. 10, 2007 (BE) 2007/0587

(51) Int. Cl. H01R 13/44

(52) U.S. Cl. 439/142

(57) ABSTRACT

USB stick (1) of the type which mainly consists of a housing (2) with a memory and a USB plug (3) protruding from an edge of the housing (2) and a cap (4) which can be provided over the USB plug (3) with an open side so as to protect the latter, characterised in that the USB stick (1) is provided with means which connect the housing (2) and the cap (4), in the open as well as in the closed position.

The present invention concerns a USB stick.

In particular, the invention concerns a USB stick of the type which mainly consists of a housing with a memory and a USB plug protruding from one edge of the housing.

It is known that such a conventional USB stick is provided with a cap which can be provided with its open side over the USB plug and which thus protects the USB plug when it is closed.

A disadvantage of such USB sticks is that the caps often get lost due to their small dimensions and are hard to find back.

That is why the cap is sometimes provided with fixing means with which it can be fixed to a bunch of keys, a necklet or the like.

However, this does not prevent the housing with the USB plug from coming off the cap while walking, exercising or the like, as a result of which the housing may get lost or the USB plug may become filthy, get damaged or become unusable, since it is no longer protected by a cap.

Also the housing may be provided with fixing means which make it possible, for example, to hang the USB stick on a bunch of keys.

These means are disadvantageous, however, in that when the USB stick is provided in a USB slot, the keys will pull at the USB stick, which may result in a bad contact, or in that the USB stick is extracted from the slot or the USB stick or the USB slot may even be damaged.

In certain computer embodiments it will not even be possible to connect the USB stick to the computer due to a lack of space around the computer's USB slot.

The present invention aims to remedy the above-mentioned and other disadvantages by providing a USB stick of the type which mainly consists of a housing with a memory and a USB plug protruding from an edge of the housing, and a cap which can be provided with an open side over the USB plug so as to protect the latter, whereby the USB stick is provided with means which connect the housing and the cap, in the open as well as in the closed position.

An advantage is that the cap stays permanently fixed to the housing, as a result of which said cap cannot get lost when using the USB stick.

In a preferred embodiment, the USB stick is provided with means for an at least temporary attachment of the USB stick to another object, whereby these means can be easily detached.

An advantage is that the USB stick can be attached to another object such as for example a key ring, a necklet and the like, such that said USB stick can be easily taken anywhere with a minimal risk of loss.

Another advantage is that the USB stick can be exchanged with different objects and that when the USB stick is attached to a necklet, for example, swapping the USB stick with another USB stick or another object can be done without necessarily having to untie the chain.

Yet another advantage linked thereto is that the USB stick and the object can be removed from one another when one wants to use the USB stick, such that the USB plug can be put directly in the slot of a computer or another appliance without being hindered by the object to which the USB stick had been attached.

Another advantage is that the USB stick can be designed as a jewel and can be carried as such, since the USB stick can be easily detached from a necklet or the like to be connected to a computer.

In order to better explain the characteristics of the invention, the following embodiments of a USB stick according to the invention are described by way of example only without being limitative in any way, with reference to the accompanying drawings, in which:

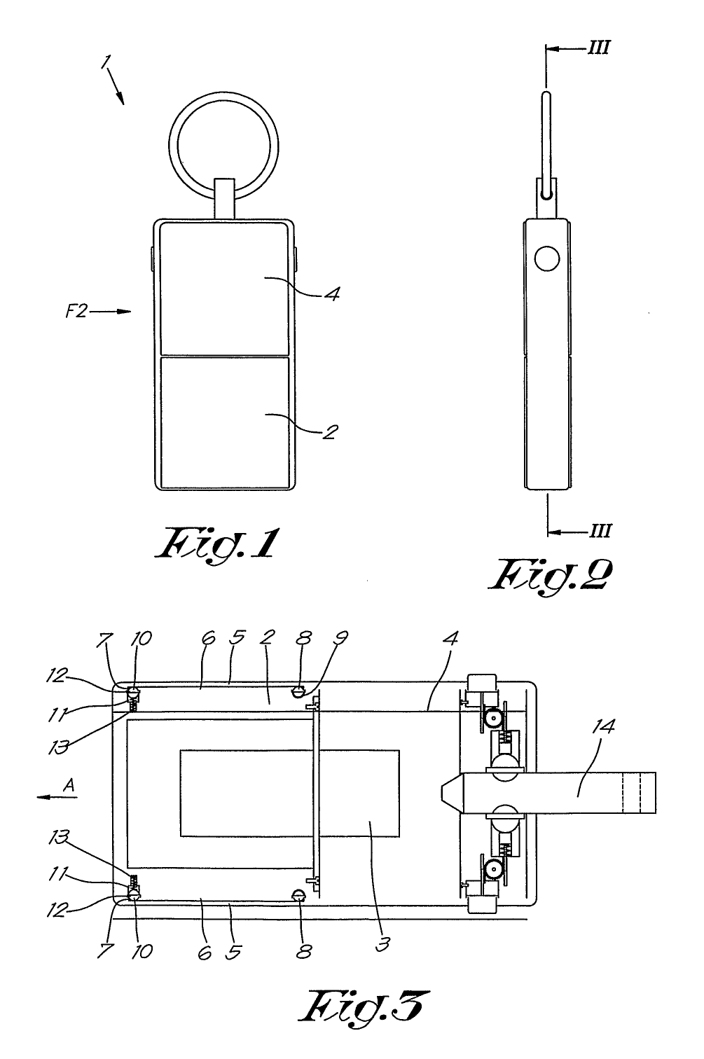

FIG. 1 schematically shows a view of a USB stick according to the invention when closed, seen in perspective;

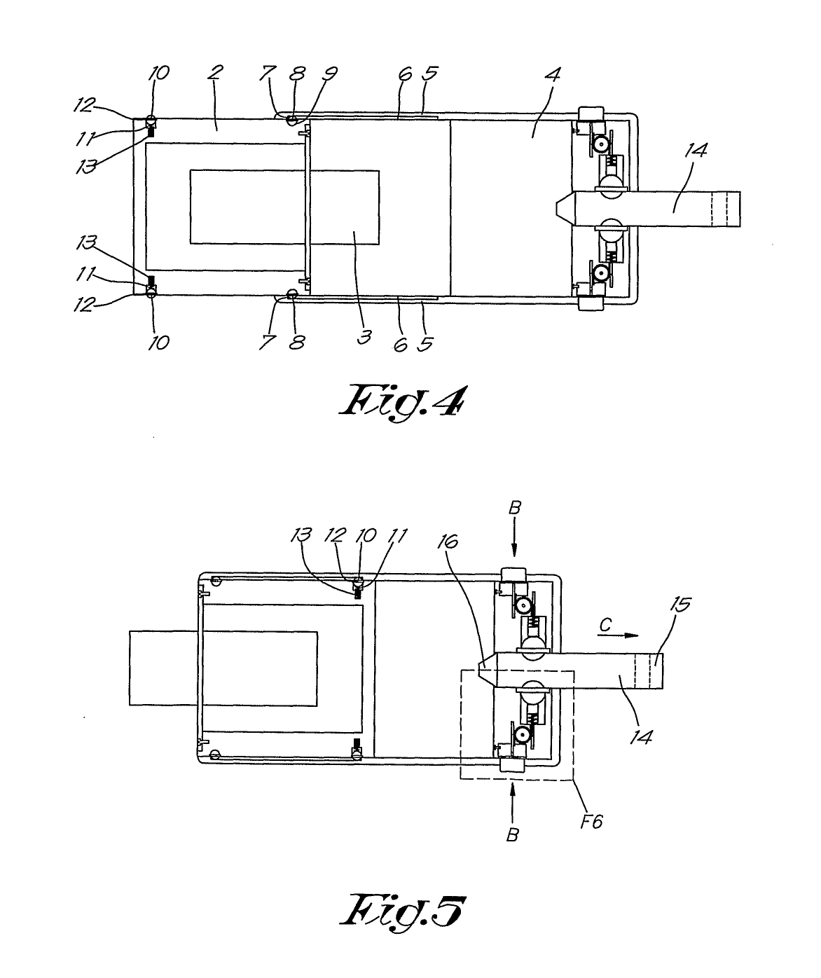

FIG. 2 shows a view according to arrow F2 in FIG. 1;

FIG. 3 shows a section of the USB stick according to line III-III in FIG. 2 when closed;

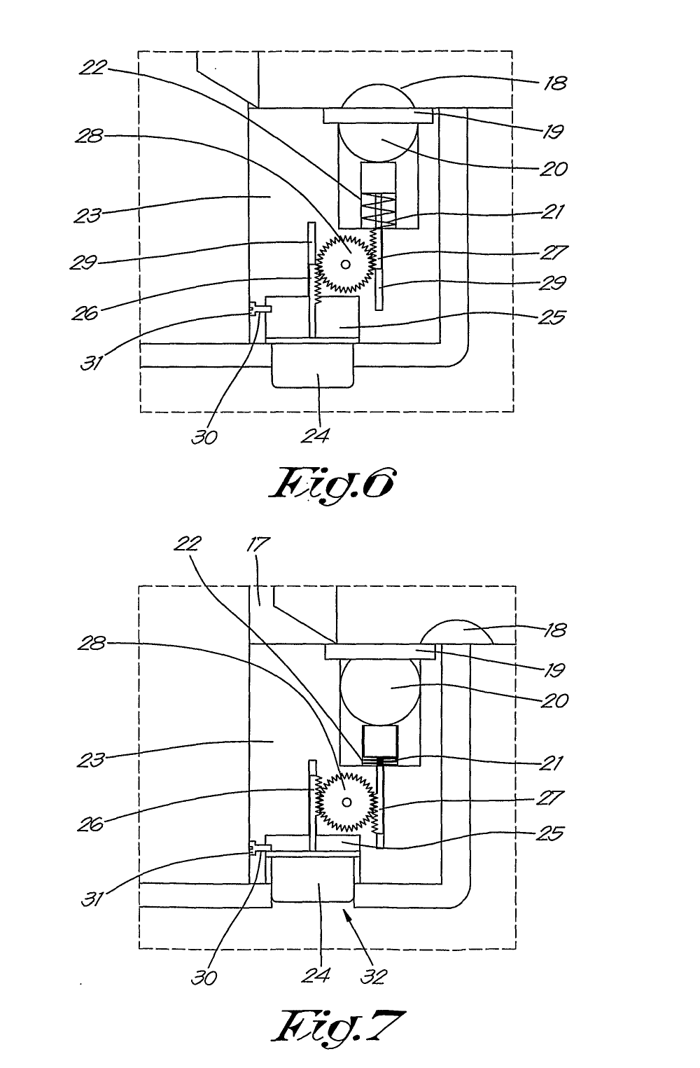

FIGS. 4 and 5 represent the USB stick of FIG. 3 in two different positions;

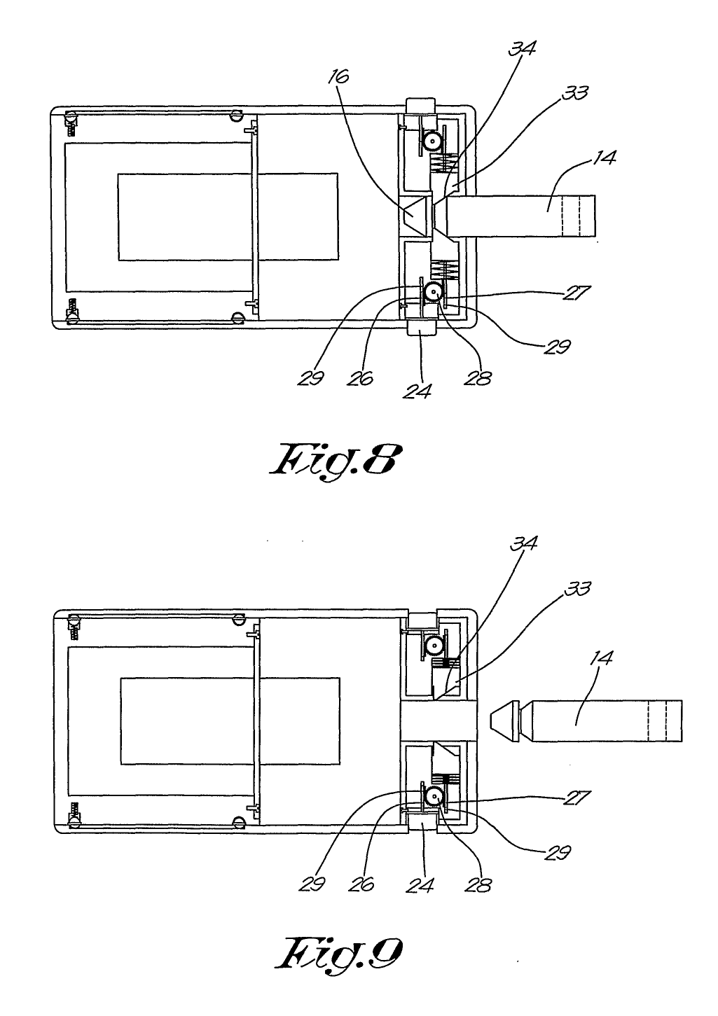

FIG. 6 is an enlargement of the part indicated by F6 in FIG. 5;

FIG. 7 is a figure analogous to that in FIG. 6, but in another position;

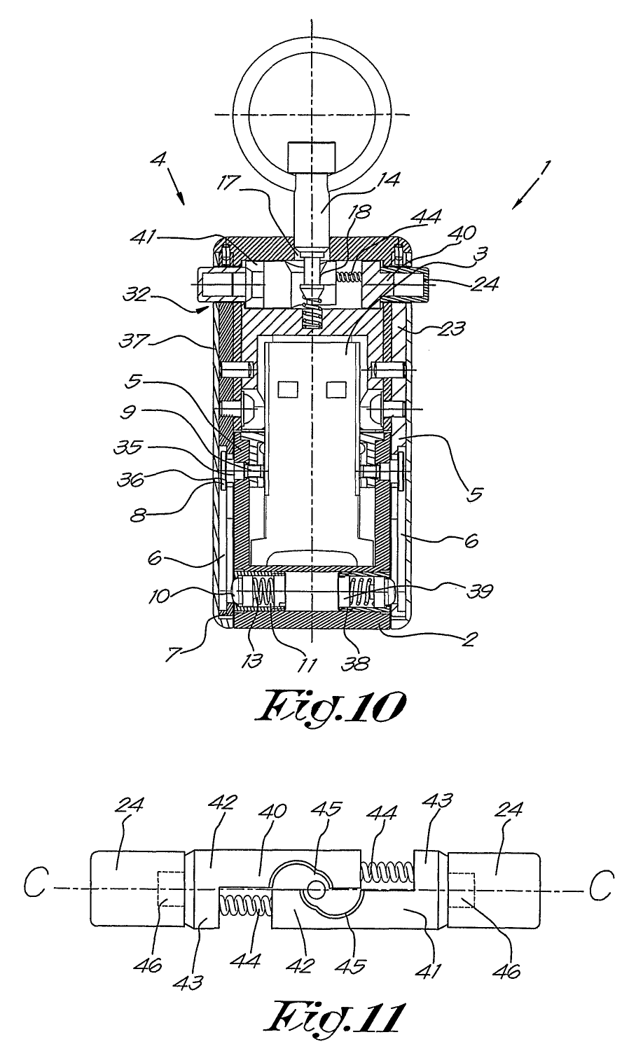

FIGS. 8 and 9 represent an alternative embodiment of the USB stick, shown in two positions.

FIGS. 1 to 3 schematically represent a USB stick 1 according to the invention which mainly consists of a housing 2 with a memory and of a USB plug 3 protruding from the edge of the housing 2 and a cap 4 which can be provided with its open side over the USB plug 3.

The USB stick 1 is further provided with means to connect the cap 4 and the housing 2 to one another, made as two parallel arms 5 in the given embodiment, which are fixed on the cap 4 and which protrude over a length in relation to the open side of the cap 4, such that the housing 2 is slidable and rotatable between said arms 5 in the longitudinal direction of the arms 5.

In each of the sides of the arms 5 that are directed towards one another is provided a groove 6 in the longitudinal direction of the arms 15, up to a short distance from the free end of the arm concerned, such that a stop 7 is formed at the free end defining the length of the groove 6.

The housing 2 is provided with at least two protrusions 8, each on a side edge of the housing 2, which are each mounted slidably in one of the above-mentioned grooves 6, and which are partly situated in a recess 9 provided to that end in the side edge of the housing 2.

These protrusions 8 are preferably made in the shape of balls and they are preferably situated at the two corners of the housing 2 on the edge from which the USB plug 3 protrudes.

Additional protrusions 10 may possibly be provided which are preferably situated at the two other corners of the housing 2 and which may be either or not made in the shape of balls, the latter protrusions 10 being partly held in a recess 11 provided to that end in the side edges of the housing 2.

Both said protrusions 10 are maintained in the recess 11 by means of a ring 12 which covers the recess 11 and whose inner diameter is smaller than the diameter of the protrusion 10.

This recess 11 is provided with a compressed spring 13 which pushes the protrusion 10 against the above-mentioned ring 12.

The method for opening the USB stick is very simple and as follows, and it is illustrated by means of FIGS. 3 to 5.

In its closed position, as represented in FIGS. 1 to 3, the USB plug 3 is protected by the cap 4 which is provided with its open side over the USB plug 3.

If one wants to use the USB stick 1 and thus detach the housing 2 with the USB plug 3 from the cap 4, a force A according to the longitudinal direction of the arms 5 will be exerted on the housing 2, as a result of which the housing 2 slides in relation to the cap 4 along the longitudinal direction of the arms 5.

The protrusions 10 will hereby be pushed over the stop 7 in the recesses 11, against the force of the springs 13, until the far end of the housing 2 has moved sufficiently, which makes it possible indeed to withdraw the housing 2 from the cap 4.

During said movement, the grooves 6 in the arms 5 form a guide for the other protrusions 8.

The sliding movement will be stopped as soon as the protrusions 8 are situated against the stops 7 of the grooves 6, as represented in FIG. 4.

The housing 2 is slidable over a length which depends on the length of the groove 6, which is such that the housing 2 is slidable over a length which is at least sufficient to draw the USB plug 3 out of the cap 4.

Next, the housing 2 can be rotated around the geometrical axis by the two protrusions 8 which are still situated in the groove 6 after the sliding movement.

It is hereby possible to rotate the housing 2 over an angle of 180° such that, as represented in FIG. 5, the USB plug 3 will be situated on the outside of the USB stick 1, ready for use.

In this condition of use, the housing 2 will be held with a certain resistance thanks to the springy action of the protrusions 10 which make contact with the arms 5 during the rotational movement of the housing 2 around the above-mentioned geometrical axis, after which, as it rotates further, the protrusions 10 are pushed in the grooves 6 of the arms 5 and thus lock the housing 2.

As can be seen in FIG. 5, the protrusions 10 are preferably situated at the far ends of the groove 6, such that the housing 2 is also locked in the longitudinal direction in the situation as represented, and it is therefore held in place when the USB plug 3 is put in a USB slot.

The method for closing off the USB stick is very simple and as follows.

By exerting a force perpendicular to the surface of the USB plug 3, and preferably as close as possible to the other side of the housing 2 than the one from which the USB plug 3 protrudes, the protrusions 10 will be pushed in their respective recesses 11 again by the edges of the grooves 6 in the arms 5, as a result of which the springs 13 are compressed.

When further pushing, the protrusions 10 pass the sides of the arms 5, and the springs 13 in the recesses 11 are released again, such that they partly push the protrusions 10 out of the recesses 11 again.

The housing 2 can be rotated until the housing 2 and the cap 4 are situated in one another's prolongation again, as represented in FIG. 4, whereby the USB plug 3 is turned towards the open side of the cap 4.

By exerting a force in the direction of the cap 4, the protrusions 8 which are situated in the grooves 6 of the arms 5 will move along the longitudinal direction of the groove 6.

During this sliding, the protrusions 10 at the free far end of the housing 2 will bump into the edges of the arms 5 and they will thus be pushed in the recesses 11 as the springs 13 are compressed.

Small notches may possibly be provided in the arms, such that the protrusions only have to be pushed partly in their recesses.

During further sliding, the springs 13 will be released again as the protrusions 10 are situated partly in the grooves 6 in the arms 5.

In this manner, the USB stick 1 is put in a stable, closed position, and the USB plug 3 is protected by the cap 4.

The USB stick 1 may further be provided with means which make it possible to fix the USB stick 1 either or not temporarily to another object, such as for example a key ring or a chain, whereby these means may be detachable, for example by means of a quick coupling.

In the embodiment as shown in the figures, said fixing means are made in the shape of a pen 14 which may be connected to an object of one's choice at its far end 15, and which may be provided in a detachable manner in a bore hole 17 of the USB stick 1 at its other far end 16, and which may be further provided with a groove 18 along the perimeter of the pen 14.

The bore hole 17 is preferably situated in the cap 4 of the USB stick 1 and it may be provided with at least one radially directed seat 19 in which can be provided a ball 20.

In the embodiment of the figures, two balls 20 have been provided, situated partly in the groove 18 of the pen 14, whereby the above-mentioned balls 20 can co-operate with the above-mentioned groove 18 in the pen 14 by means of a spring 21.

In a preferred embodiment, the USB stick 1 is further provided with means to eliminate the action of the spring 21 on the ball 20.

In the embodiment of the figures, said means are formed of an element 22 in the form of a slide situated in a guide according to the axial direction of the radial seat 19, which element 22 has been provided between the ball 20 and the spring 21 and a mechanism 15 which makes it possible to withdraw the element 22 in the direction of the bore hole 17.

Said mechanism is preferably integrated in a body 23 which is provided with two control buttons 24 which can be pushed in a recess 25 which has been provided for that purpose in the body 23.

Said control buttons 24 are each connected to a mechanism formed of two parallel gear racks 26,27 provided slidably in the body 23 in a direction which is parallel to the axial direction of the radial seat 19, and of a gear wheel 28 which is provided in a freely rotating manner between both gear racks 26,27 and which meshes in the teeth of both gear racks 26,27.

One of the gear racks 27 is connected to the above-mentioned element 22 between the spring 21 and the ball 20, whereas the other gear rack 26 which is connected to the control button 24 has been provided in a guide 29.

The body 23 may be further provided with recesses 30 in which locking screws or locking pins 31 may be provided, said recesses 30 ending in the recesses 25 of the control buttons 24.

The method for removing the fixing pen 14 is very simple and as follows.

FIG. 6 shows the situation in which the pen 14 is locked in the housing 2 as the balls 20 are pushed in the groove 18 of the pen 14 by means of the springs 21.

In order to be able to remove the pen 14 from the housing 20, the control buttons 24 are pushed in towards one another in the direction of the arrows B in FIG. 5, as a result of which the mechanism of the two gear racks 26,27 and the gear wheel 28 is activated, whereby the gear rack 26 moves in its guide 29, such that the gear wheel 28 starts to rotate and the gear rack 27 which is connected to the element 22 is set in motion in a direction opposite to the direction of movement B.

The length of the guide 29 is selected such that the gear rack 26 can shift over the required distance and prevents the control buttons 24 from being pushed in too deeply, such that the mechanism cannot be forced.

Thanks to the shifting of the gear racks 27, the elements 22 are withdrawn from the pen 14 against the action of the springs 21, such that the balls 20 can freely move in their radial seat 19 and as a result of which the pen 14 can be removed from the bore hole 17, as is shown in FIG. 7 which represents an intermediate position when withdrawing the pen 14 in the direction of the arrow C in FIG. 5.

In the embodiment shown in the figures, the USB stick 1 is secured against being accidentally detached as the pen can only be detached when both control buttons 24 are being pressed simultaneously.

The method for fixing the USB stick 1 to another object is very simple and as follows.

The pen 14, which can be connected to another object, can be pushed in the bore hole 17 provided to that end.

The pen 14 will hereby push against the balls 20 in the radial seat 19 of the bore hole 17, such that said balls 20 are pushed in a radial direction, away from the pen 14, and compress the spring 21 which is connected to the ball 20 via the element 22.

When the pen 14 is shifted further in the USB stick 1, the groove 18 in the pen 14 will be situated at a given moment under the radial seat 19 with the balls 20, the balls 20 being pushed in the groove 18 by the springs 21, and the fixing pen 14 being thus firmly connected to the USB stick 1.

Thanks to the composition of the different mechanisms, the USB stick can be attached to an object without thereby having to use the control buttons 24.

It should be noted that, as is shown in FIGS. 5 to 7, the above-mentioned body 23 is a block-shaped part which is provided in the cavity of the cap 4 of the USB stick 1, said body 23 being held in the cap 4 as the control buttons 24 protrude through passages 32 in the cap 4, the locking screws 31 preventing the buttons 24 from being pushed in too deeply, as a result of which the body 23 would be possibly released.

This type of mounting moreover makes it possible to apply the above-mentioned mechanism in a very simple manner in the cap 4 during the assembly of the USB stick 1, in the following manner.

The body 23 is pushed in the cap 4 via the open side by pressing the control buttons 24 against the force of the springs 21.

The control buttons 24 are thereby pressed entirely in their recesses 25 and they are held in this position by the locking screws 31, such that the control buttons do not form a protruding part on the body 23 and cannot be damaged while the body 23 is being inserted.

As soon as the body 23 has been pushed sufficiently far in the cap 4, such that the control buttons are situated at the provided passages, the locking screws 31 will be unscrewed, such that the springs 21 are released and the control buttons 24 are pushed through the passages 32 to the outside of the USB stick 1.

As soon as the control buttons 24 are situated on the outside of the USB stick, they will be fastened again by means of the locking screws 31.

In this manner, the body 23 will be locked in the cap 4 when mounted since the control button 24, under the influence of the above-mentioned spring 21, snaps into a passage 32 of the cap 4, and the movement of the control buttons 24 will be restricted by the locking screws 31, such that the control buttons 24 cannot be pushed in too deeply.

The body 23 can be removed from the cap 4 in a very simple manner by unscrewing the locking screws 31 and by pressing the control buttons 24, by fastening them again such that they become locked in their recesses 25, after which the body 23 can be removed from the cap 4.

In another embodiment, as represented in FIGS. 8 and 9, the balls 20 have been replaced by pens 33 which are preferably wedge-shaped and which can work in conjunction with a wedge-shaped groove in the pen 14, the slanting part 34 of the pens 33 having a slope towards the bore hole 17 in the direction of the interior of the cap 4.

The far end 16 of the pen 14 can also be provided with a conical shape having the same slope as the pens 33, such that when the pen 14 is inserted, it can co-operate with the pens 33 and push them against the direction of the spring 21.

Naturally, the pens 33 may also have other shapes such as for example cylindrical elements.

According to the invention, it is not excluded to provide the fixing means on the housing.

Nor is it excluded according to the invention to provide the housing of the USB plug with an opening in the shape of a viewing window, whereby the USB stick may be further provided with a led situated behind the viewing window, and which may indicate whether the USB stick is either or not in use.

Although the embodiments shown in the figures have two control buttons, it is not excluded according to the invention to provide only one control button and to further simplify the fastening mechanism.

The present invention is by no means restricted to the embodiment described by way of example and represented in the accompanying drawings; on the contrary, such a USB stick according to the invention can be made in all sorts of shapes and dimensions while still remaining within the scope of the invention.

1. A USB stick comprising: a housing (2) with a memory and a USB plug (3) protruding from an edge of the housing (2) and a cap (4) which can be provided over the USB plug (3) with an open side so as to protect the latter USB stick (1) being provided with means which connect the housing (2) and the cap (4), in the open as well as in the closed position, and said means further includes two parallel arms (5) which are fixed to the cap (4) and which, in relation to the above-mentioned open side, protrude from the cap (4) over a length, the housing (2) with the USB plug (3) being slidable between said arms (5) in the longitudinal direction of said arms (5) and being rotatable as well, and the housing (2) being slidable by means of at least two protrusions (8), each on a side edge of the housing (2), which protrusions (8) are mounted slidably in a groove (6) in the sides of the above-mentioned arms (5) which are directed towards one another, wherein the protrusions (8) are provided at the corners of the housing (2) on the edge from which the USB plug (3) protrudes and in that protrusions (10) are also provided at the other corners of the housing (2), which are each held in a recess (11) in the side edges of the housing (2) and which can be pressed against the force of a spring (13) situated under the protrusion (10) in the recess (11) concerned.

2. The USB stick (1) according to claim 1 wherein said housing (2) is rotatable over 180°.

3. The USB stick (1) according to claim 1 wherein said housing (2) is slidable over a length which is sufficient to pull the USB plug (3) out of the cap (4).

4. The USB stick (1) according to claim 1 wherein said protrusions (8) are balls which are partly held in a recess (9) in the above-mentioned side edges of the housing (2).

5. The USB stick according claim 1 wherein the grooves (6) are provided with a stop (7) at the free far ends of the arms (5) for the sliding movement of the above-mentioned protrusions (8).

6. The USB stick (1) according claim 2 wherein said housing (2) of the USB stick (1) is locked in a rotated, ready-for-use condition in the longitudinal direction by the protrusions (10) situated at the corners of the other edge than the one from which the USB plug (3) protrudes.

7. The USB stick (1) according to claim 1 wherein said USB stick (1) is provided with means for an at least temporary attachment of the USB stick (1) to another object, these means being detachable.

8. The USB stick (1) according to claim 7 wherein said attaching means includes a pen (14) which fits in a bore hole (17) in the USB stick (1), which bore hole (17) is provided with an at least radially directed seat (19) for a ball (20) or a pen (33) which can co-operate with a groove (18) by means of a spring (21) along the perimeter of a far end of the pen (14) so as to lock the latter.

9. The USB stick (1) according to claim 8 wherein means are provided to eliminate the action of the spring (21) on the ball (20) or the pen (33).

10. The USB stick (1) according to claim 9 wherein said means are formed of an element (22) provided between the ball (20) or the pen (33) and the spring (21) and a mechanism which makes it possible to draw the element (22) out of the bore hole (17).

11. The USB stick (1) according to claim 10 wherein said mechanism includes a control button (24) which is connected to a gear rack (26) working in conjunction with a gear wheel (28) which in turn works in conjunction with a gear rack (27) which is connected to the above-mentioned element (22) between the spring (21) and the ball (20) or the pen (33), such that when the control button (24) is pressed, the element (22) is withdrawn from the bore hole (17).

12. The USB stick (1) according to claim 10 wherein said mechanism is integrated in a body (23) which has been slided in the cap (4) via the open side with the above-mentioned control button (24) being pressed, the body (23) being locked in the cap (4) when mounted as the control button (24), snaps in a passage (32) in the above-mentioned cap (4) under the influence of the above-mentioned spring (21).

13. The USB stick (1) according to claim 12 wherein the pressing of the control button (24) is limited by a locking screw or a locking pin (31) which is inserted in the body (23) via the open side of the cap (4).

14. The USB stick (1) according to claim 7 wherein said attaching means further includes a pen (14) which fits in a bore hole (17) in the USB stick (1), whereby elements (40,41) are provided in the cap (4) such that they can slide in each other's prolongation between at least two positions, namely a first position of rest in which the elements (40,41) are pushed away from each other under the influence of at least one spring (44) and in which position the elements (40,41) define together an opening having a first diameter, and a second position in which the elements (40,41) are pushed towards one another by pressing at least one laterally protruding control button (24) and in which second position the elements (40,41) define together an opening having a second diameter which is larger than the first diameter, the second diameter being larger than the pen (14) and the first diameter being smaller than the diameter of the pen (14) but larger than the diameter of a circumferential groove (18) provided on the head of the pen (14).

15. A USB stick (1) comprising a housing (2) with a memory and a USB plug (3) protruding from an edge of the housing (2) and a cap (4) which can be provided over the USB plug (3) with an open side so as to protect the latter, whereby the USB stick (1) is provided with means which connect the housing (2) and the cap (4), in the open as well as in the closed position, and whereby the USB stick (1) is provided with means to at least temporarily attach the USB stick (1) to another object whereby these means can be detached, wherein said fixing means further includes a pen (14) which fits in a bore hole (17) in the USB stick (1), whereby elements (40,41) are provided in the cap (4) such that they can slide in each other's prolongation between at least two positions, namely a first position of rest in which the elements (40,41) are pushed away from each other under the influence of at least one spring (44) and in which position the elements define together an opening having a first diameter, and a second position in which the elements (40,41) are pushed towards one another by pressing at least one laterally protruding control button (24) and in which second position the elements define together an opening having a second diameter which is larger than the first diameter, the second diameter being larger than the pen (14) and the first diameter being smaller than the diameter of the pen (14) but larger than the diameter of a circumferential groove (18) provided on the head of the pen (14).

16. The USB stick (1) according to claim 14 wherein said first and said second diameter are obtained as the elements (40,41) are provided partly overlapping in their longitudinal direction, and in that in each of the elements (40,41) in the overlapping parts are provided two semi-circular passages, semi-circular passages with the smallest diameter being positioned further from the control button (24) with their centre than the semi-circular passages with the largest diameter.

17. A USB stick comprising a housing (2) with a memory and a USB plug (3) protruding from an edge of the housing (2) and a cap (4) which can be provided over the USB plug (3) with an open side so as to protect the latter, whereby the USB stick (1) is provided with means which connect the housing (2) and the cap (4), in the open as well as in the closed position, and whereby the USB stick (1) is provided with means to at least temporarily attach the USB stick (1) to another object whereby these means can be detached, wherein said attaching means further includes a pen (14) which fits in a bore hole (17) in the USB stick (1), which bore hole (17) is provided with an at least radially directed seat (19) for a ball (20) or a pen (33) which can co-operate with a groove (18), by means of a spring (21), along the perimeter of a far end of the pen (14) so as to lock the latter.

18. The USE stick (1) according to claim 17 wherein means are provided to eliminate the action of the spring (21) on the ball (20) or the pen (33).

19. The USB stick (1) according to claim 18 wherein said means consist of an element (22) provided between the ball (20) or the pen (33) and the spring (21) and a mechanism which makes it possible to withdraw the element (22) from the bore hole (17).

20. The USB stick (1) according to claim 19 wherein said mechanism includes a control button (24) which is connected to a gear rack (26) working in conjunction with a gear wheel (28) which in turn works in conjunction with a gear rack (27) which is connected to the above-mentioned element (22) between the spring (21) and the ball (20) or the pen (33), such that when the control button (24) is pressed, the element (22) is drawn out of the bore hole (17).

21. The USB stick (1) according to claim 19 wherein said mechanism is integrated in a body (23) which has been slided in the cap (4) via the open side while the above-mentioned control button (24) is being pressed, whereby the body (23) is locked in the cap (4) when mounted as the control button (24), under the influence of the above-mentioned spring (21), snaps in a passage (32) in the above-mentioned cap (4).

22. The USB stick (1) according to claim 21 wherein said pressing of the control button (24) is limited by a locking screw or a locking pin (31) which is inserted in the body (23) via the open side of the cap (4).
